(19) United States
(12) Patent Application Publication
(10) Pub. No.: US 2008/0092064 A1
(43) Pub. Date: Apr. 17, 2008

(54) Conceptual model for human computer interface for representing user profiles

(75) Inventor: Ran Zilca, Briarcliff Manor, NY (US)

Correspondence Address: KEUSEY, TUTUNJIAN & BITETTO, P.C., 20 CROSSWAYS PARK NORTH, SUITE 210, WOODBURY, NY, 11797, US

(73) Assignee: SIGNAL MATCH INC.

(21) Appl. No.: 11/545,892

(22) Filed: Oct. 11, 2006

(51) Int. Cl. G06F 3/00

(52) U.S. Cl. 715/757; 715/700; 707/E17.111

(57) ABSTRACT

A system and method for representing an individual in a computer network includes compiling personal data for an individual. A floor plan of a house is generated having at least one room having attributes reflective of the personal data of the individual. The floor plan is interactively displayed to permit access to the personal data by the individual and others.

### BACKGROUND

1. Technical Field

The present invention relates to human computer interfaces, and more particularly to a conceptual user interface (UI) model which may be employed in many applications in computer systems, Internet websites, mobile devices, and social networking systems.

2. Description of the Related Art

Computer user interfaces permit users to manipulate and use virtual objects that exist in computer software. User interface (UI) conceptual models introduce a correspondence between the manipulated virtual objects and real-life objects that users are familiar with through daily life experience. This is especially useful when the objects to be manipulated by the user are complex and/or exhibit complex inter-object interactions.

### SUMMARY

A system and method for representing an individual in a computer network includes compiling personal data for an individual. A floor plan of a house is generated having at least one room having attributes reflective of the personal data of the individual. The floor plan is interactively displayed to permit access to the personal data by the individual and others.

A system for representing an individual in a computer network includes a model creator configured to generate a floor plan of a house having at least one room having attributes reflective of personal data compiled for an individual. A processing device is configured to interactively display the floor plan to permit access to the personal data by the individual and others.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing a floor plan for representing a user as part of a user interface in accordance with one embodiment;

FIG. 2 is a diagram showing a town map for displaying virtual homes (floor plans) in accordance with an illustrative embodiment;

FIG. 3 is a diagram showing terrain for a town generated based upon characteristics or traits of users having a location in the town in accordance with an illustrative embodiment;

FIG. 4 is a block/flow diagram showing an illustrative system/method for representing users with a house/floor plan in a social computing system; and

FIG. 5 is a block/flow diagram showing an illustrative system/method for representing users with a house/floor plan in accordance with another embodiment.

### DETAILED DESCRIPTION OF PREFERRED EMBODIMENTS

Social networking software and community Internet web sites exhibit a high level of complexity since users need to enter and manipulate large amounts of data in their User Profile/Model (UPM). A conceptual model can therefore be useful in alleviating the complexity of manipulating UPMs, simplifying the interactions between UPMs and users, and reducing the time needed to learn how to use a new system. The UPM may include a personality model (PM) or other model representative of an individual. Although a personality model PM is illustratively described herein, other types of models may be included or used instead of the PM. For example, in addition to personality, additional measures of users may include: social attitude (which may describe a person's values and beliefs, such as, conservativeness, religious faith, patriotism, etc.); vocational interests (which may described general interests related to work, tendency to work with hands (e.g. crafts), tendency to be influential, etc.); avocational interests (e.g., interests related to non-work issues, like music, theatre, TV shows, etc.; and others.

Present embodiments address this need by introducing a user interface (UI) conceptual model where each UPM is represented by a house (or different type of home), and information shared between users and user group information is represented by the public areas of a town/village. More specifically, UPM information is distributed across the different rooms of a house, and group and inter-user information may be represented at public locations (e.g. library, bus station, bulletin boards, etc.). User interactions can also be performed in or around the houses 104 e.g., on a doorstep, in a hallway etc. Two or more users may enter the room or screen and may be depicted graphically carrying out the conversations in the area designated for the conversation. Town or village as referred to herein may include a collection, community, group or neighborhood of users in a virtual environment.

Embodiments in accordance with present principles may take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the present embodiments can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

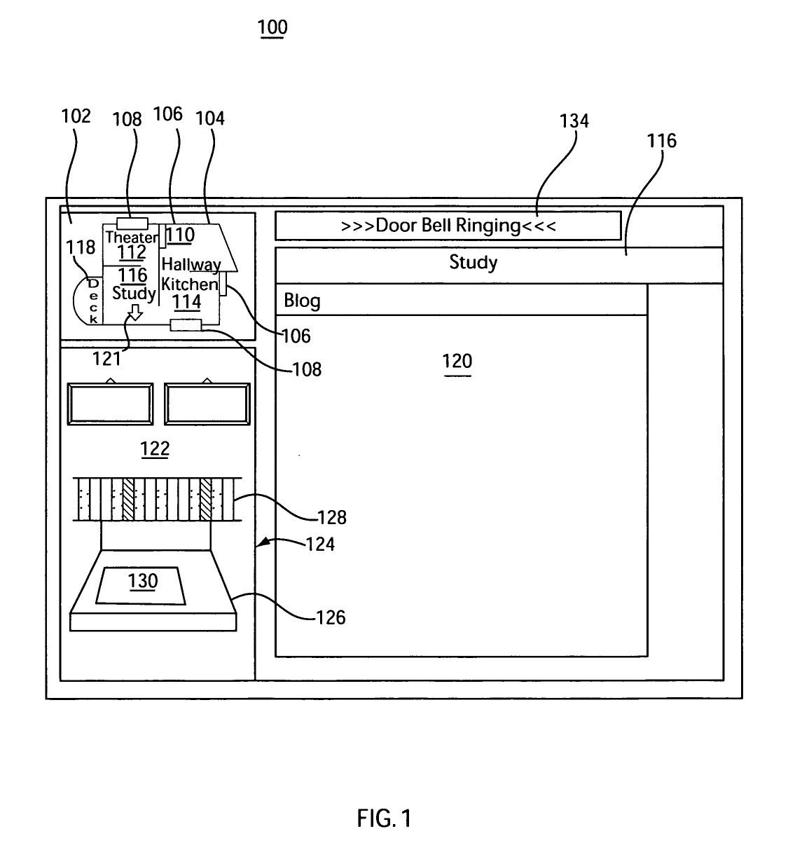

Referring now to the drawings in which like numerals represent the same or similar elements and initially to FIG. 1, an example of a user interface (UI) screenshot 100 of a system that employs embodiments of the present invention is illustratively shown. In this example, a user personality model (UPM) 102 is represented by a house or home floor plan 104. The house 104 includes doors 106 and windows 108, and in this illustrative case the following five rooms: hallway 110, theater 112, kitchen 114, study 116, and deck 118.

An arrow 121 indicates that the user is currently in the study 116, although any icon including a picture may be employed to indicate the user's position in the house 104. Every room in the house 104 corresponds to a subset of data and/or models stored in the UPM 102, and a set of functions related to this data.

For example, one of the functions available in the study room 116 is writing a Web Log (also known as a blog)—a journal or diary of the user. In the example, the user is engaged in writing a blog in work area 120. A room scene 122 is displayed on screen 124, showing a desk 126 with books 128 and a personal computer 130. The work area 120 including the blog editor and publisher is displayed in the middle and right hand side of the screen, occupying most of the space in this example.

A top of the screen 134 displays messages and notices. In this example, the top of the screen 134 displays a message indicating that the doorbell is ringing. The user can choose to answer the door and start an Instant Messaging (IM) conversation, ignore the message, or stop the message (block).

The UPM is therefore represented by analogy to a house 104, where certain rooms correspond to different data and models (including interests and contexts) that constitute the UPM. The partitioning of the UPM into rooms permits users to define different settings for different parts of their UPM. For example, privacy settings may very across rooms depending on how private and sensitive the information is. The privacy setting may be indicated by door/window (106/108) graphics or color. Advantageously, a user can designate security types of levels for any and all of the potential friends or users that they may interact with. This can be done for each individual room.

In one example, a user designates personal friends, coworkers and/or strangers. Within each context, the user can designate rooms for which that context can access. For example, the strangers can access the hallway of the house, coworkers can access the hallway, deck and study. While friends can access all rooms. This system can further differentiate between social relationships limiting some friends to certain rooms and granting full access to other friends. The user can define the context of the other user types and can adjust the status of the users over time or adjust the access or permission to rooms as desired. In this way, the user can customize access of a given individual or the class of individuals using the appropriate software tools in accordance with the present principles.

The houses (buildings or apartments) 104 that represent different users are located on virtual streets in a town/village. The information that is not tied to a specific user is represented by public locations in the town, such as, billboards on streets, a library, a town hall, restaurants, shops, etc. User interaction can be performed at users' homes, or in a public location. Users can also engage in individual experiences such as shopping (in stores on the street), reading (billboards, library), shopping mall, etc.

The conceptual user interface model described herein uses virtual objects as real world equivalents to objects that exist in computer software. In one embodiment, the following correspondence exists between real-world and software or virtual objects as will be described herein after.

Each UPM 102 is represented by a home 104 including one or more rooms. The attributes reflective of the personal data include features that adjust size, shape, color, relative dimensions, and a position of the home/room.

The home 104 can be a house, a building, townhouse, recreational vehicle, cabin, or any other form of home. Each room (e.g., 110-118) represents a subset of the parameters, variables, and general data that constitute the user UPM. In one embodiment, the kitchen 114 corresponds to the food and cuisine preferences and interests of the user. This can be represented by a relative size of the room as compared to the other rooms or a graphically representation or symbol that can indicate the type of food preferences of the user, or a general interest in cooking or dining.

The home theater room 112 may correspond to the user's preferences of music, film, and television. The theatre may include an icon which summarizes a general interest in types of music, films etc. or include a list of favorites, or a list with the user's ratings or opinions of titles on the list.

The study 116 may represent the user's professional and academic interests (e.g. work resume, publications, and professional memberships). The study room 116 may also include the user's book preferences, although this may be included in a library or other room (not shown).

The deck 118 may include the user's recreational preferences (such as sports and travel). As mentioned, an icon, e.g., a skier, etc., may be employed to indicate that skiing is a dominant sports interest of the user.

Additional special rooms may also be defined according to the user's specific interests. For example, a recording studio room may be available to the user when they can process music data and remix it to include new music and audio tracks such as podcasts.

In one embodiment, each room has different privacy and authorization settings, permitting users to define which other users are permitted to view the content of the room and/or edit the content. For example, users may choose that the hallway of their house can be publicly viewed by any other user (but not edited), whereas the kitchen access is available only to a predetermined set of friends (for both viewing and editing). These features may be implemented by a user and graphically depicted by doors 106 and windows 108. Alternately, an icon or other graphic may be employed to denote a security level. For example, when a room is selected the image in screen 124 may be blank or prompt a user for a password. If the password matches a list of passwords, the user is granted access. Other security systems may also be employed.

Psychological and social models in the UPM can reside in one or more rooms of each home 104. In one embodiment, the UPMs reside in a bedroom which can be accessed only by the user who owns the home. The UPMs which may be employed are described in U.S. Provisional Applications Ser. No. 60/772,638, filed Feb. 13, 2006 and Ser. No. 60/795,238, filed Apr. 25, 2006, which are hereby incorporated by reference in their entirety.

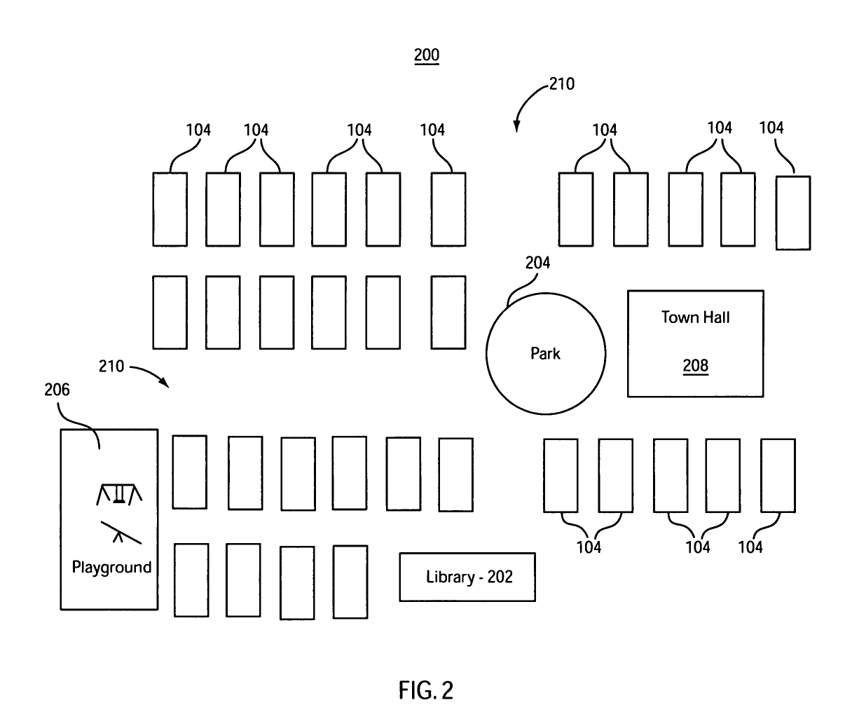

Referring to FIG. 2, to complement the correspondence of users and their UPM with homes 104, the environment in which the homes are located will also be analogous to data and activities that can be shared by multiple users. The users will therefore reside in a virtual town or village 200, where public locations permit users to interact. For example, a public library 202, park 204, playground 206, town hall 208, etc. The type of user interaction is specific to the location. For example, user postings related to recreational activities will be accessed in the park 204.

Streets 210 in FIG. 2 may represent different common characteristics or personality traits of the users' that reside on them. For example, users may be classified based on similar interests, actual proximity of residence, personality types, etc. Streets may also be named accordingly, to indicate these features. In addition, the town/village 200 may itself be created based on a common feature, characteristic etc. of the users. Just as a home 104 is placed on a map of a town 200, a plurality of towns may be viewed on a larger map and so on.

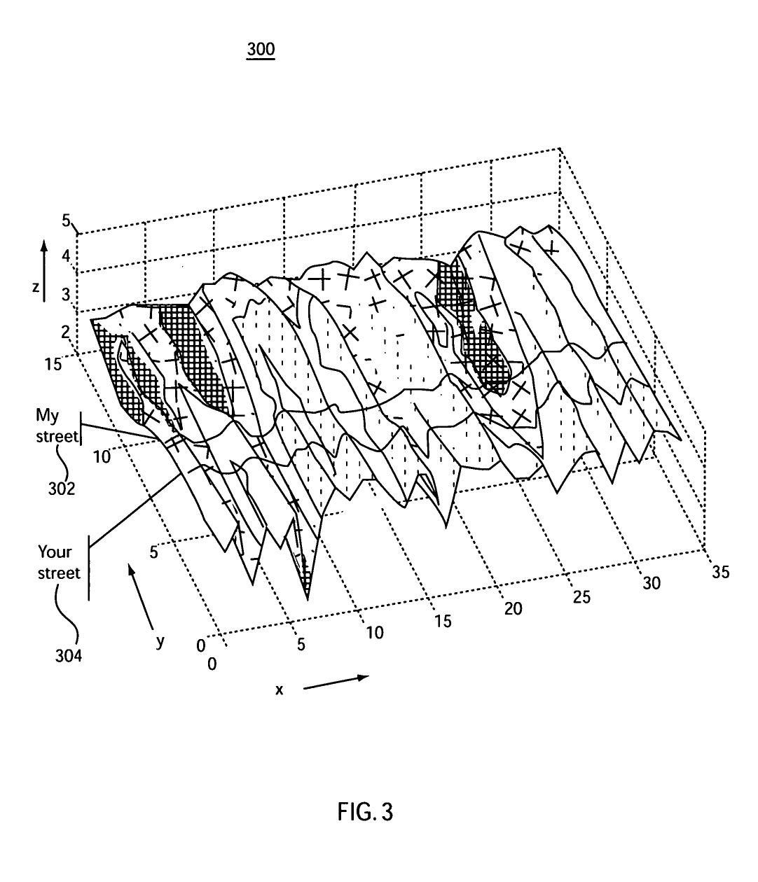

Referring to FIG. 3, in other aspects, terrain 300 of the town/village 200 may correspond to the personality and social traits of users, such that from a bird's eye view the town 200 is shown as a map or a collection of streets as depicted in FIG. 3. Each street or neighborhood can correspond to a group of users with similar psychological, social, and interest/preferences traits. Users can zoom in the map, and view individual streets and neighborhoods, where the neighbors or residents of the same street share some UPM attributes or are similar in some UPM models.

In this illustrative embodiment, terrain map 300 indicates personality and social traits of users. The x and y axes may indicate the physical location of the map 200 while the z-axis may indicate a relative score or index of the personality traits. For example, if the trait was say, friendliness a score of “5” would indicate very friendly and “2” somewhat friendly, etc. In this way, for a given trait, information about users can be obtained in a general way to conduct a visual search based upon a particular characteristic.

In addition, multiple locations may be highlighted on the terrain 300. The terrain for the virtual town may include streets corresponding to a cluster of a self organizing map. (see e.g., Kohonen, T. (1995). Self-Organizing Maps. Series in Information Sciences, Vol. 30. Springer, Heidelberg. Second ed. 1997).

For example, My street 302 and Your street 304 may be indicated for comparison. In this way a user may selected to move to a different location in map 200 based on the responses or characteristics of other users. A screen view of terrain 300 may be selected using the user interface of map 200 or screen 100, for example.

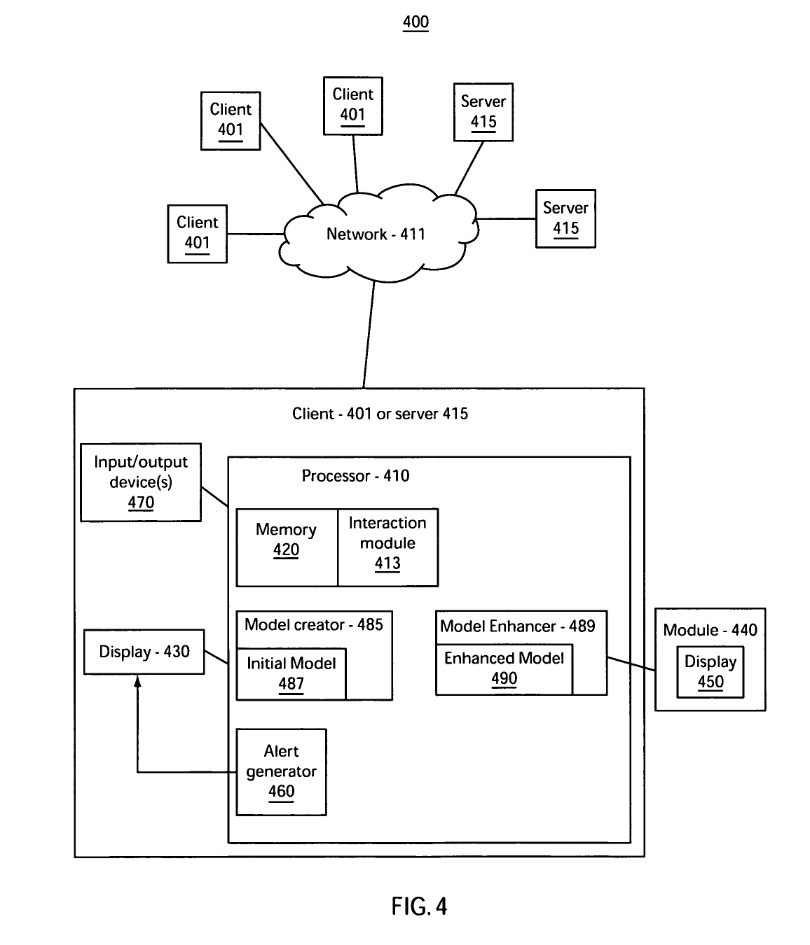

Referring to FIG. 4, a social computing system 400 is shown in accordance with an illustrative embodiment. The system 400 includes clients 401. Each client may be implemented on a single processor 410 or a plurality of processors distributed over a network 411. Processors 410 are each operationally coupled to a memory 420, a display 430, an input/output (I/O) device(s) 470, and to other modules or device 440, which may be implemented in hardware software or a combination thereof. Device 440 may include a handheld or portable device (PDA, telephone, computer, etc.) that connects to the system and includes display 450.

The memory 420 may be any type of device for storing application data as well as other data, such as personality profiles or models. The application data and other signals such as personality search and/or match requests, are received by the processor 410 for configuring the processor 410 to perform operations in accordance with the present system. Processors 410 may include or be employed as a server 415 to handle interactions between users. Server 415 may be employed to provide maps and terrain displays for matching or interaction services, provide and update user profiles/user models, and otherwise provide services to users/clients 401. Clients 401 may be equipped to provide these services as well depending on software loaded thereon.

Processor 410 (or server 415) and memory 420 may include hardware and/or software that functions as an interaction module 413 capable providing system operations and services to a user or users.

The operations include controlling at least one of the display 430 or a display 450 to display a user interface (UI) that depicts a visual environment that may be larger than the respective displays 430, 450, such as a world view or town/village view map (200 or 300). The input/output 470 may include a keyboard, mouse, or other device, including touch sensitive displays, which may be stand alone or part of a system, such as part of a personal computer, personal digital assistant or cell phone, for communicating with the processor via any type of link, such as wired or wireless link(s).

An alert generator 460 may be included for generating a display icon on the display 430 or user interface display 450, when messages or other data are present. Display 430 may include a liquid crystal display (LCD), a cathode ray tube (CRT), etc.

The module 440 (and/or processor display 430) may perform other operations including displaying television signals, a gaming environment, etc. Only a single display is needed for operation, although additional displays may also be utilized or other peripheral device introduced into the system 400.

The methods of the present system 400 are particularly suited to be carried out by a computer software program, such computer software program preferably includes modules corresponding to the individual steps or acts of the methods. Such software can of course be embodied in a computer-readable medium, such as an integrated chip, a peripheral device or memory, such as the memory 420 or other memory coupled to the processor 410.

The computer-readable medium and/or memory 420 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, and/or a wireless channel using, for example, time-division multiple access, code-division multiple access, or other wireless communication systems). Any medium known or developed that can store information suitable for use with a computer system may be used as the computer-readable medium and/or memory 420.

Additional memories may also be employed. The computer-readable medium, the memory 420, and/or any other memories may be long-term, short-term, or a combination of long- and-short term memories. These memories configure processor 410 to implement the methods, operations, and functions disclosed herein. The memories may be distributed or local and the processor 410, where additional processors may be provided, may be distributed or singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 420, for instance, because the processor 410 may retrieve the information from the network.

The processor 410 and memory 420 may be any type of processor/controller and memory, such as those described in U.S. Application No. 2003/0057887, which is incorporated herein by reference. The processor 410 is capable of providing control signals and/or performing operations in response to input signals from the I/O device 470 and/or module 440, and executing instructions stored in the memory 420. The processor 410 may be an application-specific or general-use integrated circuit(s). Further, the processor 410 may be a dedicated processor for performing in accordance with the present system or may be a general-purpose processor wherein only one of many functions operates for performing in accordance with the present system. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems.

Individual users interact with a processor 410 or server 415 to access a model creator 485 configured to create an initial model 487 of a user. The initial model 487 may include a floor plan of a hose based on attributes of the user's personality. The initial model 487 may be created in a plurality of ways, for example, the initial model 487 may be created based on a questionnaire of a user's personality, by recording and analyzing the user's interaction with other users in the social network, by creating the initial from or augmenting the initial model by direct input from other users. Further, the initial model may be created from or augmented by using a world personality model that describes a personality of a group of users.

For example, information may be gathered about an individual based on their preferences or opinions. In one embodiment, music clips may be played for a user and the user is asked to select a multiple choice response regarding their impression of the song. Instead of a question, a music clip is employed. Collecting these responses or ratings of music (video, sounds, images, etc.) may be employed to adjust personal data, effect models or provide a demographic for sending content to the user (e.g., recommending products and services).

The user can then interact with system features to provide further details on the construction and visualization of the house (104) that represents that user or the processor 410 may provide the appearance based on default settings associated with the attributes of the model. For example, the user may stock the rooms with icons, lists, objects alter features of the rooms to customize the house. The location of the user in a virtual town map may be selected by the user, selected by the server 415 (or processors 410), based on defaults or a combination of both. Concurrently and over time, the system 400 may employ a model enhancement module 489 feature to analyze and record interactions of the user with other users in the social network to update and adjust the initial model 487 to provide an enhanced model 490 for the user. The enhanced model 490 may be enhanced based on a questionnaire of a user's personality, by recording and analyzing the user's interaction with other users in the social network, by updating the initial model by direct input from other users. The enhanced model may be created from or augmented by using a world personality model that describes a personality of a group of users.

An interaction module 413 provides user services and is configured to permit interaction between users by employing one of the initial model 487 and the enhanced model 490 of each user. For example, the interaction module 413 can calculate a personality match score between at least two models of users in the social network indicating closeness based on one or more criteria. The personality match score may be calculated for a specific predefined type of relationship. The interaction module 413 can group users by personality types, where a personality type is a descriptor of the user personality based on the personality test assessment methods. The grouping may include the generation or a terrain (300). In addition, the interaction module 413 can group users by personality types, where a personality type is a descriptor of the user personality based on input from other users.

The interaction module 413 permits searches for users based on at least one of a personality match score of user models and a same personality type. Module 413 handles all browsing activities of the users.

In a particularly useful embodiment, the interaction module 413 adjusts a user interaction interface based on at least one of personality models, personality match scores, and personality types. E.g., colors, window size, textures, and functions may be adjusted based on the individual user's personality model, personality type or interactions with another user based on the match score. For instance, in a match score is high, during interaction between the highly matched pair different interface features are observed and provided for the highly matched pair.

The interaction module 413 may provide the maps and terrain graphics as described with reference to FIGS. 1-3.

In another feature, the interaction module 413 can send content and/or recommendations for content to users based on one or more of personality models, personality types, and personality match scores. The content may include recommendations for products and services that are relevant to the user based on the model. It should be understood that the model creator 487, the model enhancer 489, and interaction model 413 may be located on a server 415 and not accessible by clients 401. During interactions between clients 401, server 415 monitors activities and updates the user models accordingly. Server 415 may further permit user searches, etc. by storing the latest versions of all of the user personality models or profiles.

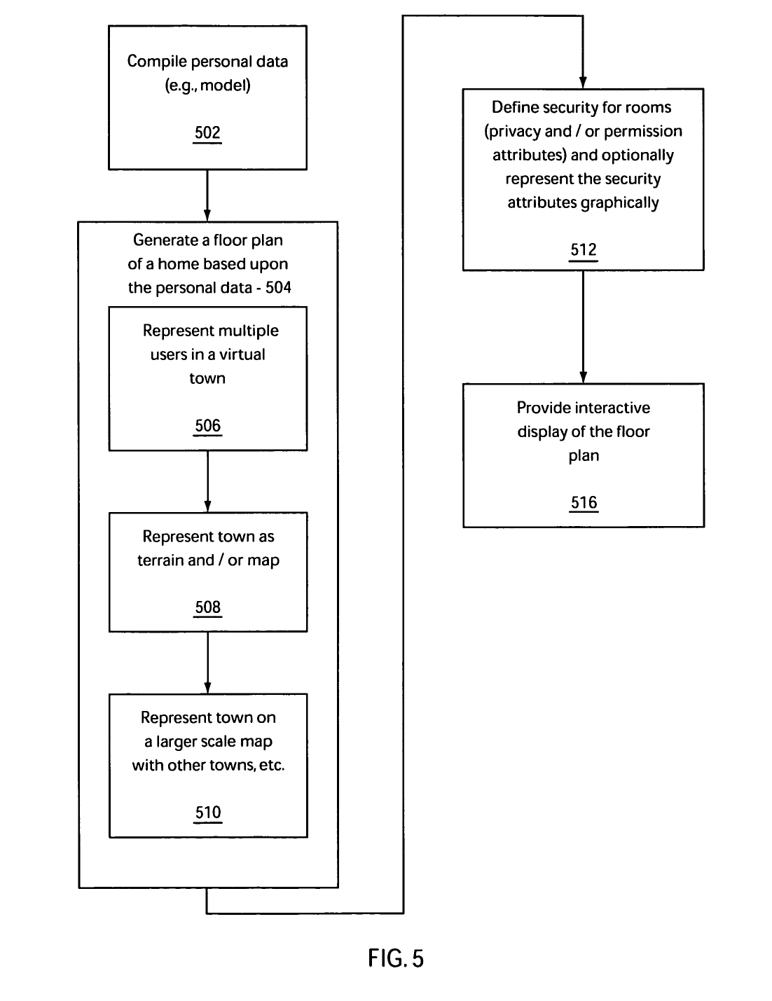

Referring to FIG. 5, a method for representing an individual in a computer network includes compiling personal data for an individual in block 502. This may include employing a personality model for the user. In block 504, a floor plan of a house is generated having at least one room having attributes reflective of the personal data of the individual. The floor plan may include a plurality of rooms, each room including attributes in the floor plan which are representative of a different social trait or characteristic of the user. Other attributes reflective of the personal data may include at least one of size, shape, color, relative dimensions, and a position of the rooms in the house.

Generating the floor plan may include representing multiple users by homes in a virtual town in block 506. In block 508, the virtual town may be represented by a terrain or a map. Terrain may be generated for the virtual town based on a characteristic(s) of the users with houses in the virtual town. The terrain for the virtual town may be generated using e.g., streets corresponding to a cluster of a self organizing map. The view of the virtual town may also be given by a map that includes different attributes of a community and individuals in the community. The virtual town may be represented on a larger scale (world view) with other virtual towns in block 510.

In block 512, privacy and/or permission attributes are defined for each room. This may include graphically representing the privacy and permission attributes for each room. In block 514, an interactive display of the floor plan is provided to permit access to the personal data by the individual and others (in accordance with the privacy and/or permission attributes).

Having described preferred embodiments of a system and method conceptual model for human computer interface for representing user profiles (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for representing an individual in a computer network, comprising:
compiling personal data for an individual;
generating a floor plan of a house having at least one room having attributes reflective of the personal data of the individual; and
interactively displaying the floor plan to permit access to the personal data by the individual and others.

2. The method as recited in claim 1, wherein generating the floor plan includes representing multiple users by homes in a virtual town.

3. The method as recited in claim 2, further comprising generating terrain in the virtual town based on a characteristic of the users with houses in the virtual town.

4. The method as recited in claim 2, wherein a view of the virtual town is given by a map that includes different attributes of a community and individuals in the community.

5. The method as recited in claim 2, further comprising representing the virtual town on a larger scale with other virtual towns.

6. The method as recited in claim 2, further comprising generating terrain for the virtual town including streets corresponding to a cluster of a self organizing map.

7. The method as recited in claim 1, wherein the floor plan includes a plurality of rooms, each room including attributes in the floor plan which are representative of a different social trait or characteristic of the user.

8. The method as recited in claim 1, further comprising defining at least one of privacy and permission attributes for each room.

9. The method as recited in claim 8, wherein representing the privacy and permission attributes for each room includes specifying access rights for each room for known and unknown users.

10. The method as recited in claim 1, wherein the personal data include a model for one of a personality, social attitude, vocational and avocational interests of the user.

11. The method as recited in claim 1, wherein the attributes reflective of the personal data include at least one of size, shape, color, relative dimensions, and a position.

12. A computer program product for representing an individual in a computer network comprising a computer useable medium including a computer readable program, wherein the computer readable program when executed on a computer causes the computer to perform the steps of:
compiling personal data for an individual;
generating a floor plan of a house having at least one room having attributes reflective of the personal data of the individual; and
interactively displaying the floor plan to permit access to the personal data by the individual and others.

13. A system for representing an individual in a computer network, comprising:
a model creator configured to generate a floor plan of a house having at least one room having attributes reflective of personal data compiled for an individual; and
a processing device configured to interactively display the floor plan to permit access to the personal data by the individual and others.

14. The system as recited in claim 13, wherein multiple users are represented by homes in a virtual town.

15. The system as recited in claim 14, further comprising terrain in the virtual town wherein the terrain is based on a characteristic of the users with houses in the virtual town.

16. The system as recited in claim 14, further comprising a map of the virtual town such that the map includes different attributes of a community and individuals in the community.

17. The system as recited in claim 14, further comprising a larger scale map representing the virtual town with other virtual towns.

18. The system as recited in claim 13, wherein the floor plan includes a plurality of rooms, each room including attributes in the floor plan which are representative of a different social trait or characteristic of the user.

19. The system as recited in claim 13, further comprising at least one of privacy and permission attributes for each room to prevent access by others.

20. The system as recited in claim 13, wherein the attributes reflective of the personal data include at least one of size, shape, color, relative dimensions, and a position.
